(19) United States
(12) Patent Application Publication
(10) Pub. No.: US 2026/0227621 A1
(43) Pub. Date: Aug. 6, 2026

(54) ALL-IN-FOCUS IMAGE GENERATION

(71) Applicant: HAMAMATSU PHOTONICS K.K., Hamamatsu-shi (JP)

(72) Inventors: Masaki IIZUKA, Shizuoka (JP); Satoshi TSUCHIYA, Shizuoka (JP)

(21) Appl. No.: 19/461,752

(22) Filed: Jan. 28, 2026

Related U.S. Application Data
(63) Continuation of application No. PCT/JP2024/018716, filed on May 21, 2024.

(30) Foreign Application Priority Data
Sep. 22, 2023 (JP) 2023-158157

(51) Int. Cl. G02B 21/36

(52) U.S. Cl. CPC G02B 21/367

(57) ABSTRACT

A method of generating an all-in-focus image includes: acquiring an original image for each focal position of an object by capturing an image of the object while shifting the focal position in a predetermined direction; performing frequency decomposition on the original image for each focal position to generate an edge image for each frequency band; generating an all-in-focus edge image for each frequency band by integrating the edge images for each frequency band in the predetermined direction; and generating the all-in-focus image by integrating the all-in-focus edge images for each frequency band.

### CROSS-REFERENCE TO RELATED APPLICATIONS

This application is a continuation application of PCT Application No. PCT/JP2024/018716, filed on May 21, 2024, which claims the benefit of priority from Japanese Patent Application No. 2023-158157, filed on Sep. 22, 2023. The entire contents of the above listed PCT and priority applications are incorporated herein by reference.

### BACKGROUND

### Field

The present disclosure relates to an all-in-focus image generation method, an all-in-focus image generation device, and an all-in-focus image generation program.

### Description of the Related Art

International Publication No. WO 2018/042629 discloses a method in which a plurality of images (Z-stack images) having different focal positions are acquired by capturing an image of the same object in the thickness direction (Z-axis direction) of the object while shifting its focal position and an all-in-focus image, in which each pixel is in focus, is generated from the Z-stack images

In the method of International Publication No. WO 2018/042629, an all-in-focus image is generated by collecting, from the acquired Z-stack images, pixels (pixels indicating focal positions) of images having the maximum degree of focus at each pixel position. Specifically, the degree-of-focus calculation unit calculates the degree of focus at every pixel position of the two-dimensional images forming the Z-stack images, and transmits the calculated degree of focus to the all-in-focus image generation unit. The all-in-focus image generation unit selects the pixel values of any two-dimensional image in the Z direction that has the highest degree of focus (extracts focal positions), and generates an all-in-focus image by combining the selected pixel values at all pixel positions.

### SUMMARY

An example method of generating all-in-focus image may include: acquiring, as a respective original image for each focal position related to an object, an image captured for each focal position by capturing an image of the object while shifting the focal position in a predetermined direction; extracting a frequency component in each of the original images for each focal position to generate a respective edge image for each frequency band; generating a respective all-in-focus edge image for each frequency band by integrating the edge images for each frequency band in the predetermined direction; and generating the all-in-focus image by integrating the all-in-focus edge images for each frequency band.

### BRIEF DESCRIPTION OF THE DRAWINGS

FIG. 1 is a block diagram illustrating an example all-in-focus image generation device.

FIG. 2 is a diagram illustrating an example original image acquired by the all-in-focus image generation device of FIG. 1.

FIG. 3 is a flowchart illustrating an example all-in-focus image generation method.

FIG. 4 is an illustrative diagram of the all-in-focus image generation method of FIG. 3.

FIG. 5 is a flowchart illustrating an example frequency decomposition step shown in the all-in-focus image generation method of FIG. 3.

FIG. 6 is an illustrative diagram of the example frequency decomposition step of FIG. 5.

FIG. 7 is a flowchart showing an example method for generating all-in-focus edge images.

FIG. 8 is an illustrative diagram of a frequency decomposition step according to a first modification example.

FIG. 9 is a flowchart illustrating an all-in-focus image generation method according to a second modification example.

FIG. 10 is an illustrative diagram of a selection step shown in the all-in-focus image generation method of FIG. 9.

FIG. 11 is a flowchart illustrating an all-in-focus image generation method according to a third modification example.

FIG. 12 is an illustrative diagram of a conversion step shown in the all-in-focus image generation method of FIG. 11.

FIG. 13 is a flowchart illustrating a frequency decomposition step according to a fourth modification example.

FIG. 14 is an illustrative diagram of the frequency decomposition step of FIG. 13.

FIG. 15 is a diagram illustrating an example application of an image information determination model according to a fifth modification example.

FIG. 16 is a block diagram illustrating an example all-in-focus image generation program and a recording medium therefor.

FIG. 17 is an illustrative diagram of an all-in-focus image generation method using patches according to Comparative examples 1 and 2.

FIG. 18 is a diagram illustrating an example evaluation target sample.

FIG. 19 is a diagram illustrating results of calculating a first evaluation index and a second evaluation index.

FIG. 20 is a diagram illustrating results of an example processing time measured from the acquisition of an original image to the generation of an all-in-focus image.

### DETAILED DESCRIPTION

In the following description, with reference to the drawings, the same reference numbers are assigned to the same components or to similar components having the same function, and overlapping description is omitted.

### All-In-Focus Image Generation Device

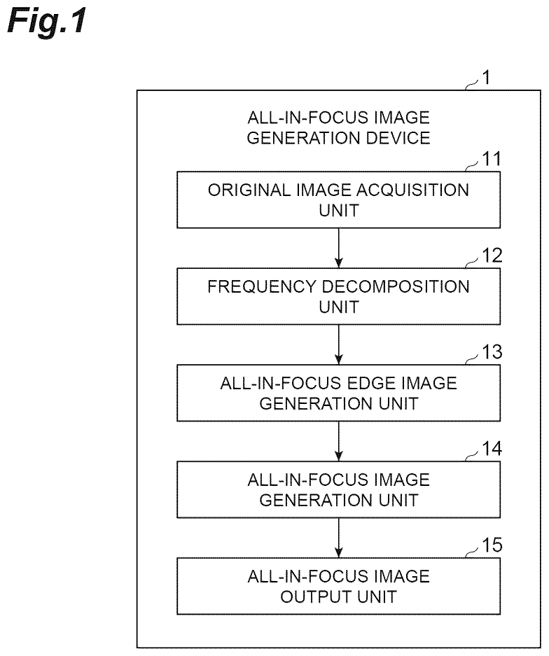

FIG. 1 is a block diagram showing an example all-in-focus image generation device. An all-in-focus image generation device 1 generates an all-in-focus image, in which each pixel is in focus, from original images acquired for each focal position (a plurality of original images).

In some examples, the all-in-focus image generation device 1 is configured as a device that acquires original images for each focal position by capturing an image of a cell sample placed on a slide glass and generates an all-in-focus image of the cell sample. The generated all-in-focus image is used, for example, for cytological diagnosis and pathological diagnosis.

The all-in-focus image generation device 1 includes an original image acquisition unit 11, a frequency decomposition unit 12, an all-in-focus edge image generation unit 13, an all-in-focus image generation unit 14, and an all-in-focus image output unit 15. The frequency decomposition unit 12, the all-in-focus edge image generation unit 13, the all-in-focus image generation unit 14, and the all-in-focus image output unit 15 may comprise one or more processing devices, controllers, or computers including a processor, such as a CPU, and a non-transitory tangible computer readable storage medium, such as a RAM and a ROM. The all-in-focus image generation device 1 may include a smart device such as a smartphone or tablet terminal that integrally includes a display unit and an input unit. In some examples, a computer may be configured by a microcomputer or an FPGA (Field-Programmable Gate Array).

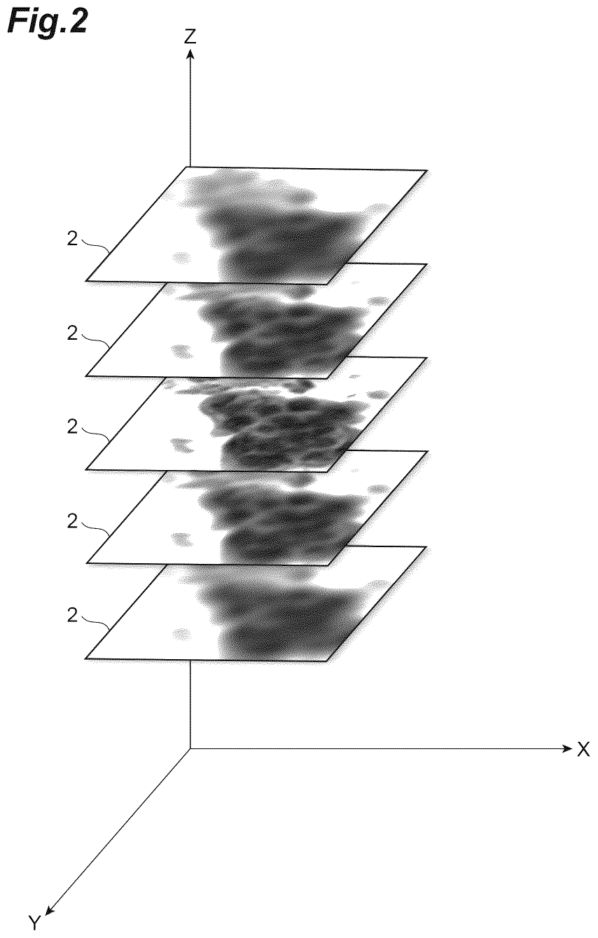

The original image acquisition unit 11 acquires original images for each focal position. The original image acquisition unit 11 includes an imaging device. The imaging device is, for example, a microscope imaging device, and captures a magnified image of an object placed on a stage. FIG. 2 is a diagram showing an example of the original image for each focal position acquired by the original image acquisition unit 11. The original image acquisition unit 11 acquires an original image 2 of an object having a thickness. Here, for convenience of explanation, the thickness direction of the object is defined as a Z-axis direction. In addition, the direction perpendicular to the Z-axis direction is defined as an X-axis direction, and the direction perpendicular to the Z-axis direction and the X-axis direction is defined as a Y-axis direction. The original image acquisition unit 11 captures an image of the object multiple times successively while shifting the focal position in the Z-axis direction (predetermined direction) in a state in which the position of the same object at the time of imaging (position in the X-axis direction and the Y-axis direction) other than the Z-axis direction is fixed. In this manner, the original image acquisition unit 11 acquires the original images 2 for each focal position, each having a different focal position. Since the original images 2 for each focal position are continuous in the Z-axis direction, these are referred to as Z-stack images.

The frequency decomposition unit 12 generates edge images for each frequency band (a plurality of edge images) by performing frequency decomposition on each of the original images 2 for each focal position. The frequency decomposition unit 12 receives the original images 2 for each focal position from the original image acquisition unit 11. Each of the original images 2 for each focal position includes frequency components that indicate the intensity of the edge at its focal position. The frequency decomposition unit 12 generates edge images for each frequency band by sequentially extracting frequency components included in each original image 2 in order from the highest frequency band.

The all-in-focus edge image generation unit 13 generates an all-in-focus edge image for each frequency band by integrating the edge images for each frequency band in the Z-axis direction. The all-in-focus edge image generation unit 13 receives the edge images for each frequency band from the frequency decomposition unit 12. The all-in-focus edge image generation unit 13 generates an all-in-focus edge image for each frequency band by integrating pixels indicating the focal positions from edge images for each focal position (a plurality of edge images sharing the same frequency band), among the edge images for each frequency band, in the Z-axis direction (predetermined direction).

The all-in-focus image generation unit 14 generates a single all-in-focus image by integrating the all-in-focus edge images for each frequency band. The all-in-focus image generation unit 14 receives the all-in-focus edge images for each frequency band from the all-in-focus edge image generation unit 13. The all-in-focus image generation unit 14 outputs the generated all-in-focus image to the all-in-focus image output unit 15.

The all-in-focus image output unit 15 displays the all-in-focus image generated by the all-in-focus image generation unit 14 on an external display (not shown), for example. Alternatively, the all-in-focus image output unit 15 transfers the generated all-in-focus image to an external recording medium or device, for example.

### All-In-Focus Image Generation Method

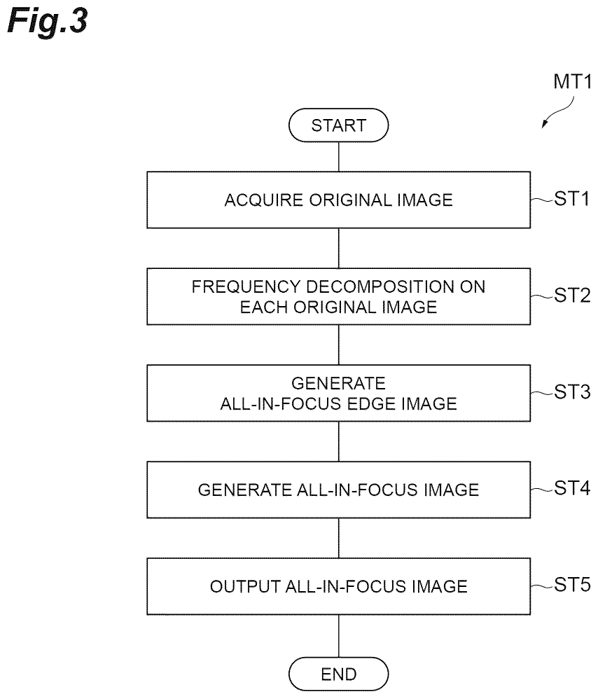

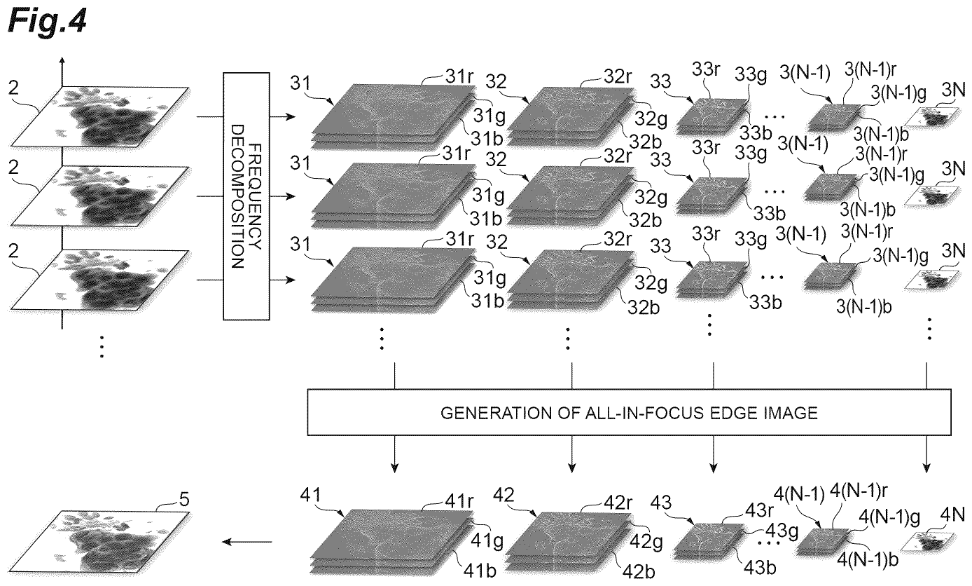

Next, an example all-in-focus image generation method will be described with reference to FIGS. 3 and 4. FIG. 3 is a flowchart showing an all-in-focus image generation method (hereinafter, a method MT1). FIG. 4 is a diagram for explaining the all-in-focus image generation method.

The method MT1 starts with the original image acquisition unit 11 capturing the original images 2 for each focal position. First, the original image acquisition unit 11 acquires the original images 2 for each focal position (original image acquisition step: step ST1).

Then, the frequency decomposition unit 12 performs frequency decomposition on the original images 2 for each focal position, thereby generating edge images for each frequency band (frequency decomposition step: step ST2). The frequency decomposition unit 12 extracts frequency components that indicate the intensity of the edge at the focal position included in each original image 2 in order from the highest frequency band. In some examples, the frequency decomposition unit 12 repeatedly filters each original image 2 to sequentially extract high-frequency components. The edge images for each frequency band include, in each frequency band, edge images for each focal position that share the same frequency band.

In step ST2, the frequency decomposition unit 12 decomposes the original images 2 for each focal position into a plurality of color component images, and performs frequency decomposition on each of the plurality of color component images. The plurality of color component images are, for example, a red image, a green image, and a blue image. The frequency decomposition unit 12 generates edge images for each frequency band in each of the plurality of color component images.

As shown in FIG. 4, in step ST2, edge images 31 to 3 (N−1) for each frequency band and a bottom-layer image 3N (a plurality of bottom-layer images) for each focal position are generated. Here, N indicates an integer of 2 or more.

In the example of FIG. 4, the frequency decomposition unit 12 performs frequency decomposition on each original image 2 N times, thereby generating (N−1) edge images for each frequency band and one bottom-layer image for each original image 2. Each of the (N−1) edge images for each frequency band corresponds to each frequency band. The (N−1) edge images for each frequency band are, in order from the highest frequency band, an edge image 31 generated by the first frequency decomposition, an edge image 32 generated by the second frequency decomposition, an edge image 33 generated by the third frequency decomposition, and an edge image 3 (N−1) generated by the (N−1)-th frequency decomposition.

Each original image 2 may include a plurality of in-focus points at its focal position. In some examples, in step ST2, the frequency decomposition unit 12 extracts, for example, a plurality of in-focus points in order from the highest degree of focus.

The edge images 31 to 3 (N−1) for each frequency band include, in each frequency band, edge images for each focal position that share the same frequency band. The edge image 31 for each focal position, the edge image 32 for each focal position, the edge image 33 for each focal position, the edge image 3 (N−1) for each focal position, and the bottom-layer image 3N for each focal position are generated in the same number as the original images 2 for each focal position. The edge images 31 to 3 (N−1) for each frequency band and the bottom-layer image 3N for each focal position have different focal positions among the plurality of images in each frequency band.

As described above, the frequency decomposition unit 12 generates an edge image for each frequency band in each of the plurality of color component images in the original images 2 for each focal position. Therefore, each edge image 31 for each focal position includes a red image 31r, a green image 31g, and a blue image 31b. Each edge image 32 for each focal position includes a red image 32r, a green image 32g, and a blue image 32b. Each edge image 33 for each focal position includes a red image 33r, a green image 33g, and a blue image 33b. Each edge image 3 (N−1) for each focal position includes a red image 3 (N−1) r, a green image 3 (N−1) g, and a blue image 3 (N−1) b.

In FIG. 4, a red image 3Nr, a green image 3Ng, and a blue image 3Nb are not shown in the bottom-layer image 3N for each focal position. This is because no edge image is generated from the bottom-layer image 3N for each focal position, and the bottom-layer image 3N is thus distinguished from the edge images 31 to 3 (N−1) for each frequency band. The bottom-layer image 3N for each focal position includes the red image 3Nr, the green image 3Ng, and the blue image 3Nb.

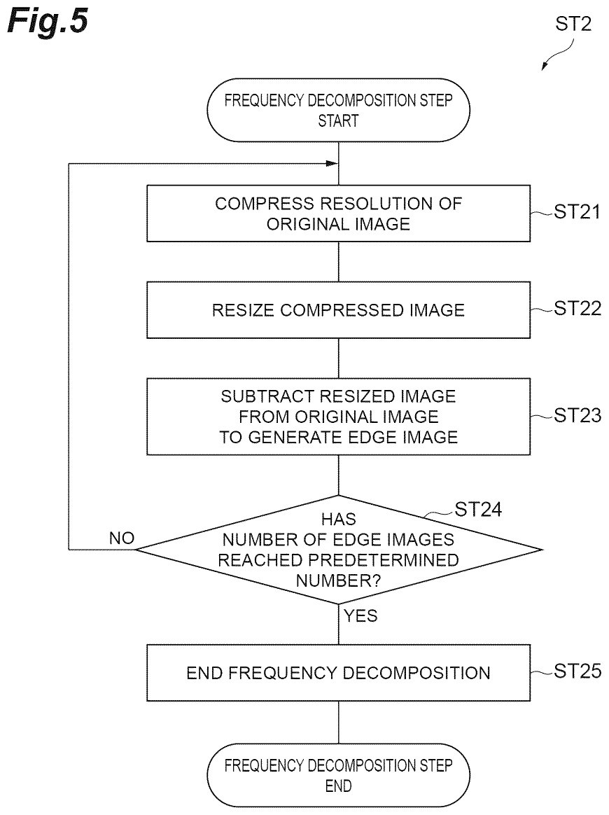

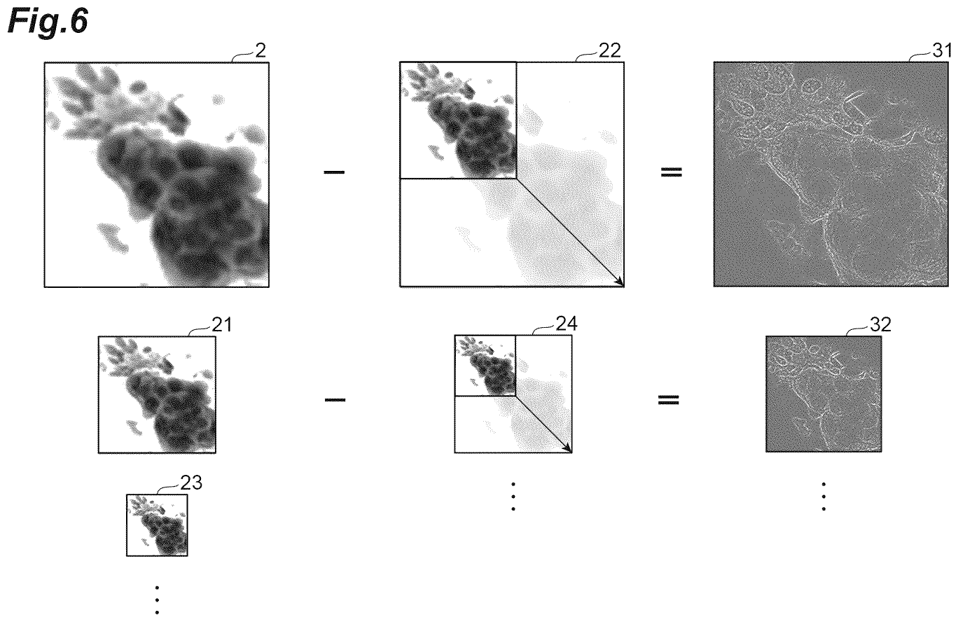

Here, an example of step ST2 will be described with reference to FIGS. 5 and 6. In the example of FIGS. 5 and 6, the frequency decomposition unit 12 performs frequency decomposition on each original image 2 using a Laplacian pyramid. First, the frequency decomposition unit 12 reduces the resolution of each original image 2 to half, using each original image 2 as a base image (step ST21).

Then, the frequency decomposition unit 12 resizes a compressed image 21 (step ST22). A resized image 22 has the same resolution as the original image 21. Therefore, the resized image 22 becomes a blurred image compared to the original images 2 because it lacks the high frequency components of the original image 2. Then, the frequency decomposition unit 12 subtracts the image 22 from each original image 2 to generate the edge image 31 in which the high frequency components of each original image 2 are selectively extracted (step ST23).

Then, the frequency decomposition unit 12 determines whether or not the number of edge images for each frequency band generated from each original image 2 has reached a predetermined number (step ST24). In some examples, the predetermined number is (N−1). If the number of edge images for each frequency band has not reached the predetermined number (step ST24: NO), the frequency decomposition unit 12 performs frequency decomposition again from step ST21 using the image 21 as a base image. The frequency decomposition unit 12 repeats step ST21 N times and steps ST22 and ST23 (N−1) times.

If the number of edge images for each frequency band reaches the predetermined number (step ST24: YES), the frequency decomposition unit 12 ends the frequency decomposition (step ST25). In some examples, the frequency decomposition unit 12 ends the frequency decomposition when (N−1) edge images for each frequency band are generated.

FIGS. 3 and 4 are referred to again. After the frequency decomposition unit 12 generates the edge images 31 to 3 (N−1) for each frequency band and the bottom-layer image 3N for each focal position, the all-in-focus edge image generation unit 13 generates all-in-focus edge images 41 to 4 (N−1) (a plurality of all-in-focus edge images) for each frequency band and an all-in-focus bottom-layer image 4N from the edge images 31 to 3 (N−1) for each frequency band and the bottom-layer image 3N for each focal position (all-in-focus edge image generation step: step ST3).

In step ST3, the all-in-focus edge image generation unit 13 generates an all-in-focus edge image for each frequency band in each of the plurality of color component images. As a result, the all-in-focus edge image 41 includes an all-in-focus red image 41r, an all-in-focus green image 41g, and an all-in-focus blue image 41b. The all-in-focus edge image 42 includes an all-in-focus red image 42r, an all-in-focus green image 42g, and an all-in-focus blue image 42b. The all-in-focus edge image 43 includes an all-in-focus red image 43r, an all-in-focus green image 43g, and an all-in-focus blue image 43b. The all-in-focus edge image 4 (N−1) includes an all-in-focus red image 4 (N−1) r, an all-in-focus green image 4 (N−1) g, and an all-in-focus blue image 4 (N−1) b.

The all-in-focus edge images 41 to 4 (N−1) for each frequency band are (N−1) images. Each of the (N−1) all-in-focus edge images for each frequency band corresponds to each frequency band. Each of the all-in-focus edge images 41 to 4 (N−1) is formed by integrating the pixels of the edge images in the corresponding frequency band. The (N−1) all-in-focus edge images for each frequency band are the all-in-focus edge image 41, the all-in-focus edge image 42, the all-in-focus edge image 43, and the all-in-focus edge image 4 (N−1) in order from the highest frequency band.

The all-in-focus bottom-layer image 4N is one image. The all-in-focus bottom-layer image 4N is formed by integrating the pixels of the bottom-layer image 3N for each focal position.

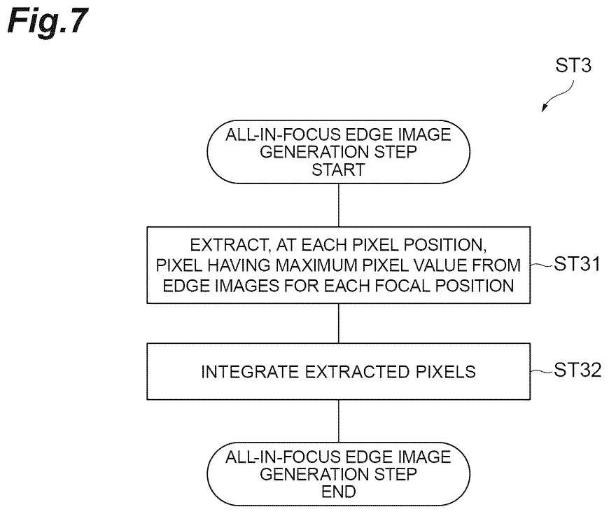

FIG. 7 is a diagram showing an example of a method for generating the all-in-focus edge images 41 to 4 (N−1) for each frequency band and the all-in-focus bottom-layer image 4N. An example maximum value extraction method will be described, in which Step ST3 includes steps ST31 to ST33.

First, the all-in-focus edge image generation unit 13 extracts, at each pixel position of the all-in-focus edge images 41 to 4 (N−1) and the all-in-focus bottom-layer image 4N, a pixel having the maximum pixel value from the edge images for each focal position, among the edge images 31 to 3 (N−1) for each frequency band, and the bottom-layer image 3N for each focal position (step ST31). For example, when generating the all-in-focus edge image 41, the all-in-focus edge image generation unit 13 extracts a pixel having the highest pixel value from the edge image 31 for each focal position at each pixel position of the all-in-focus edge image 41. The pixel having the highest pixel value is a pixel that is in focus among the edge images 31 for each focal position.

Then, the all-in-focus edge image generation unit 13 generates all-in-focus edge images by integrating the pixels extracted at all pixel positions of the all-in-focus edge image 41 to 4 (N−1) and the all-in-focus bottom-layer image 4N (step ST32). Each of the all-in-focus edge images 41 to 4 (N−1) is an image that is in focus at all pixel positions. For example, the all-in-focus edge image generation unit 13 generates the all-in-focus edge image 41 by integrating the pixel values of the edge images 31 for each focal position extracted at all pixel positions of the all-in-focus edge image 41.

Then, the all-in-focus image generation unit 14 generates one all-in-focus image from each of the all-in-focus edge images 41 to 4 (N−1) and the all-in-focus bottom-layer image 4N (all-in-focus image generation step: step ST4). The all-in-focus image generation unit 14 generates an all-in-focus image 5, for example, by the following procedure. The all-in-focus image generation unit 14 generates an image having twice the resolution of the all-in-focus bottom-layer image 4N. Then, the all-in-focus image generation unit 14 adds the image having twice the resolution of the all-in-focus bottom-layer image 4N to the all-in-focus edge image 4 (N−1). The all-in-focus image generation unit 14 generates the all-in-focus image 5 by repeating these steps until the all-in-focus edge image 41 is added.

Finally, the all-in-focus image output unit 15 outputs the all-in-focus image 5 (ST5). The method MT ends with the output of the all-in-focus image 5.

As described above, in the method MT1 according to one aspect of the present disclosure, by acquiring the original images 2 for each focal position that are shifted from one another in focal position and extracting, for each frequency band, the frequency components included in each of the original images 2 for each focal position, the edge images 31 to 3 (N−1) for each frequency band and the bottom-layer image 3N for each focal position are generated. Since the frequency components include information indicating the focal position (edge intensity at the focal position) in each original image 2, performing frequency decomposition on each original image 2 enables accurate extraction of the focal position in the edge images 31 to 3 (N−1) for each frequency band and the bottom-layer image 3N for each focal position. In each of the all-in-focus edge images 41 to 4 (N−1), which is generated for each frequency band by integrating the edge images 31 to 3 (N−1) for each frequency band and the bottom-layer image 3N for each focal position, information indicating different focal positions for each frequency band is reflected, and all pixels are in focus. Accordingly, the all-in-focus image 5 may be generated with high accuracy without extracting a specific region from the original image 2.

In step ST2, each of the original images 2 for each focal position is decomposed into a plurality of color component images, and each of the plurality of color component images is frequency-decomposed to generate, for each frequency band, a plurality of edge images corresponding to the plurality of color component images. By performing frequency decomposition on each of the plurality of color component images and generating edge images for each frequency band corresponding to the plurality of color component images, information indicating different focal positions for each color component image can be further reflected in the all-in-focus image 5. In this manner, the all-in-focus image 5 may be generated with even higher accuracy.

### MODIFICATION EXAMPLES

It is to be understood that not all aspects, advantages and features described herein may necessarily be achieved by, or included in, any one particular example. Indeed, having described and illustrated various examples herein, it should be apparent that other examples may be modified in arrangement and detail.

### First Modification Example

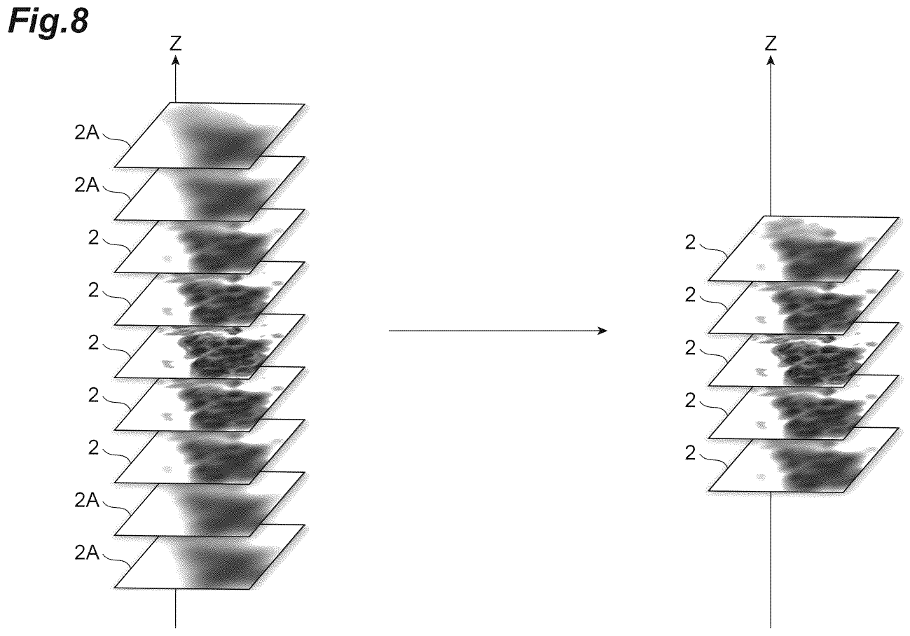

Step ST2 may include a step of excluding original images that do not include a focal position. FIG. 8 is a diagram for explaining the step of excluding original images that do not include a focal position. The frequency decomposition unit 12 excludes, from the acquired original images 2 for each focal position, original images 2A that do not include a focal position at all pixel positions. In the example of FIG. 8, there are a plurality of original images 2A that do not include a focal position. The original image 2 in the top layer, the original image 2 in a layer immediately below the top layer, the original image 2 in the bottom layer, and the original image 2 in a layer immediately above the bottom layer are excluded as the original images 2A that do not include a focal position. In some examples, there may be only one original image 2A that does not include a focal position.

The original image acquisition unit 11 may calculate a variance value as an index when the frequency decomposition unit 12 excludes the original image 2A that does not include a focal position. For example, the frequency decomposition unit 12 calculates the deviation of pixel values for all pixels of each original image 2, and calculates a variance value of each original image 2 from the calculated deviation. The original image 2A that does not include a focal position tends to have a small variance value. When the variance value of each original image 2 falls below a variance threshold, the frequency decomposition unit 12 excludes the original image as the original image 2A that does not include a focal position. Alternatively, as an index value for excluding the original image 2A that does not include a focal position, the frequency decomposition unit 12 may perform edge detection using a first-order or second-order differential. The frequency decomposition unit 12 may exclude the original image 2, in which no edges are detected as a result of edge detection, as the original image 2A that does not include a focal position.

In step ST2, the frequency decomposition unit 12 may exclude the original image 2A that does not include a focal position, among the original images 2 for each focal position, from the frequency decomposition targets. By excluding the original image 2A that does not include a focal position, the number of images to be decomposed in step ST2 can be reduced and the speed at which the all-in-focus image 5 is generated can be improved.

### Second Modification Example

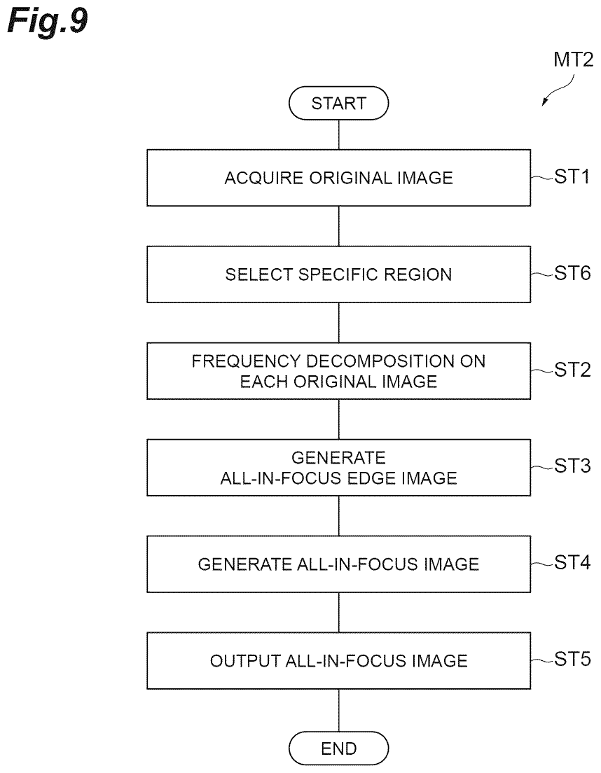

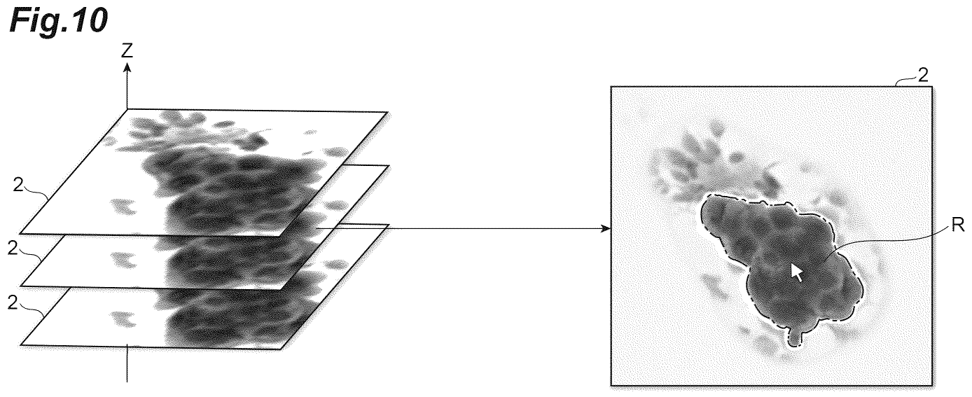

FIG. 9 is a flowchart showing an all-in-focus image generation method according to a second modification example (hereinafter, referred to as a method MT2). The method MT2 is different from the method MT1 in that a step of selecting a specific region (step ST6) is included between steps ST1 and ST2. FIG. 10 is a diagram for explaining step ST6. As shown in FIG. 10, the original image acquisition unit 11 selects a specific region R to be brought into focus in each original image of the acquired original images 2 for each focal position, based on, for example, a user input from a user interface. The specific region R can be selected arbitrarily by the user, for example. The outer edge of the specific region R may be a curved or a straight line. The specific region R is common to all of the original images 2 for each focal position.

In the method MT2, the steps from step ST2 are executed for the specific region R. For example, the steps from step ST2 are executed on the pixels included in the specific region R. In step ST2, by performing frequency decomposition on the specific region R in each of the original images 2 for each focal position, edge images 31 to 3 (N−1) for each frequency band and a bottom-layer image 3N for each focal position are generated in the specific region R in each of the original images 2 for each focal position.

In step ST3, the all-in-focus edge image generation unit 13 generates, in the specific region R, all-in-focus edge images 41 to 4 (N−1) for each frequency band and an all-in-focus bottom-layer image 4N (step ST3). In step ST4, the all-in-focus image generation unit 14 generates an all-in-focus image 5 in which the specific region R is in focus. In examples in which the specific region R is in focus, all pixels included in the specific region R are in focus, while regions other than the specific region R are out of focus.

In some examples of the method MT2, step ST6 may be executed by the original image acquisition unit 11. However, in other examples, the all-in-focus image generation device 1 may further include a selection unit for selecting the specific region R, and the selection unit may select the specific region R based on, for example, a user input from a user interface.

The method MT2 may further include step ST6 (selection step) of selecting the specific region R in the original image 2 for each focal position. In step ST2, the specific region R in each of the original images 2 for each focal position may be frequency-decomposed, and the edge images 31 to 3 (N−1) for each frequency band and the bottom-layer image 3N for each focal position in the specific region R may be generated. Since the amount of data of the image to be decomposed in step ST2 can be reduced, the speed at which the all-in-focus image 5 is generated may be improved. In addition, the specific region R referred to herein may be selected for the purpose of reducing the amount of data without affecting the accuracy of the all-in-focus image 5.

### Third Modification Example

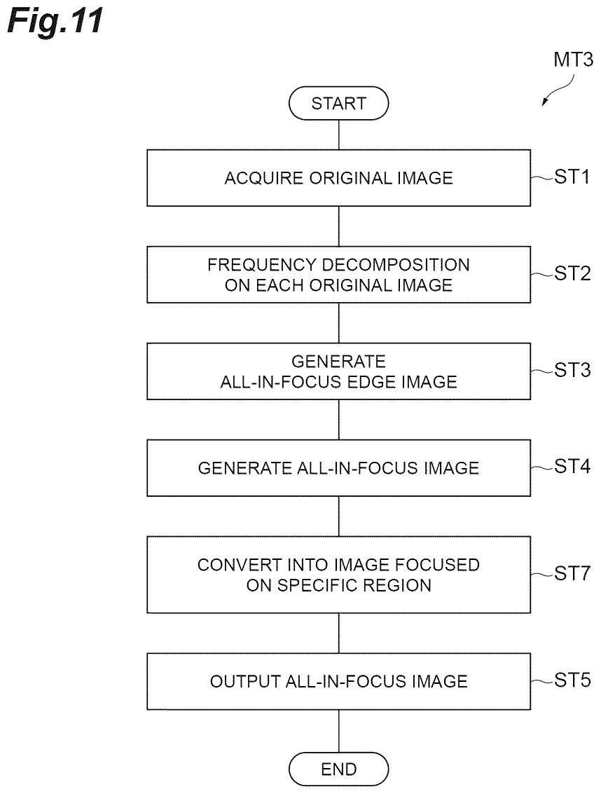

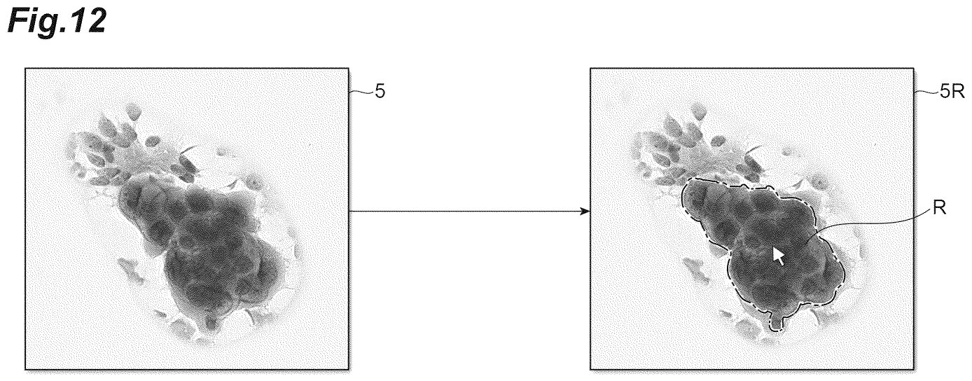

FIG. 11 is a flowchart showing an all-in-focus image generation method according to a third modification example (hereinafter, referred to as a method MT3). The method MT3 is different from the method MT1 in that, after step ST4, a step of converting the all-in-focus image 5 into an image focused on a specific region (step ST7) is included. FIG. 12 is a diagram for explaining step ST7. In step ST7, as shown in FIG. 12, the all-in-focus image generation unit 14 selects a specific region R to be brought into focus from the generated all-in-focus image 5 based on, for example, a user input from a user interface. The specific region R can be selected arbitrarily by the user, for example. The outer edge of the specific region R may be a curve or a straight line.

Then, in step ST7, the all-in-focus image generation unit 14 converts the all-in-focus image 5 into an image 5R in which the selected specific region R is in focus. In the image 5R, all pixels included in the specific region R are in focus, while regions other than the specific region R are out of focus.

In step ST7, the all-in-focus image generation unit 14 may convert the all-in-focus image 5 into the image 5R by reducing the resolution of regions other than the specific region R in the all-in-focus image 5. The all-in-focus image generation unit 14 may also convert the all-in-focus image 5 into the image 5R by cutting out regions other than the specific region R from any of the original images 2 for each focal position or an image obtained by averaging the pixel values of the original images 2 for each focal position and applying the cut-out regions to the all-in-focus image 5.

In the example method MT3, step ST7 may be executed by the all-in-focus image generation unit 14. However, in other examples, the all-in-focus image generation device 1 may further include a conversion unit, and the conversion unit may convert the all-in-focus image 5 into an image focused on a specific region.

The method MT3 may further include step ST7 (conversion step) of selecting the specific region R in the all-in-focus image 5 and converting the all-in-focus image 5 into the image 5R in which the specific region R is in focus. Since the all-in-focus image 5 can be converted into the image 5R in which the specific region R is selectively placed in focus, the usability of the all-in-focus image 5 may be improved.

### Fourth Modification Example

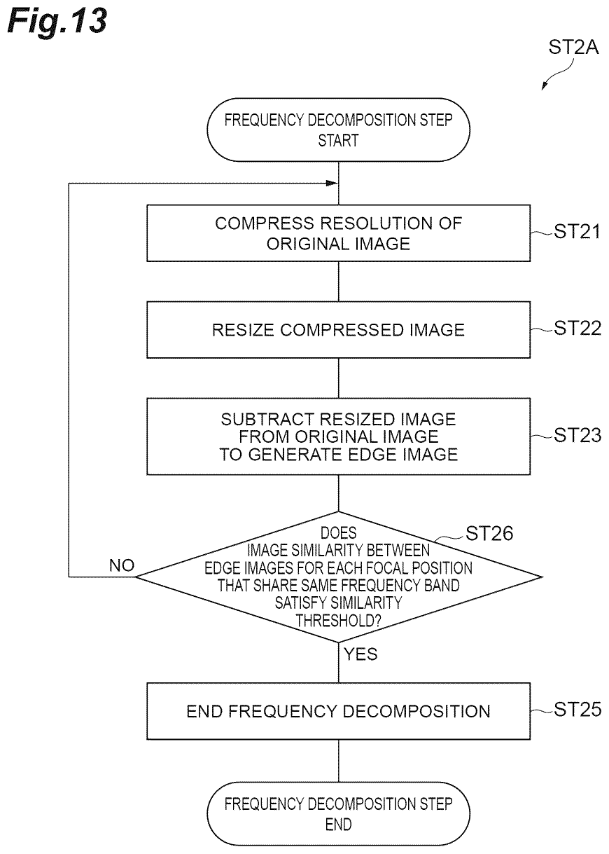

FIG. 13 is a flowchart showing step ST2A according to a fourth modification example. Step ST2A is different from step ST2 in that step ST2A includes step ST26 instead of step ST24. In step ST26, the frequency decomposition unit 12 determines whether or not the image similarity between edge images for each focal position that share the same frequency band, in the edge images 31 to 3 (N−1) for each frequency band, satisfies a similarity threshold. In step ST2A, the frequency decomposition unit 12 calculates the image similarity between edge images for each focal position, and if the image similarity satisfies a predetermined similarity condition, the frequency decomposition unit 12 stops the subsequent frequency decomposition.

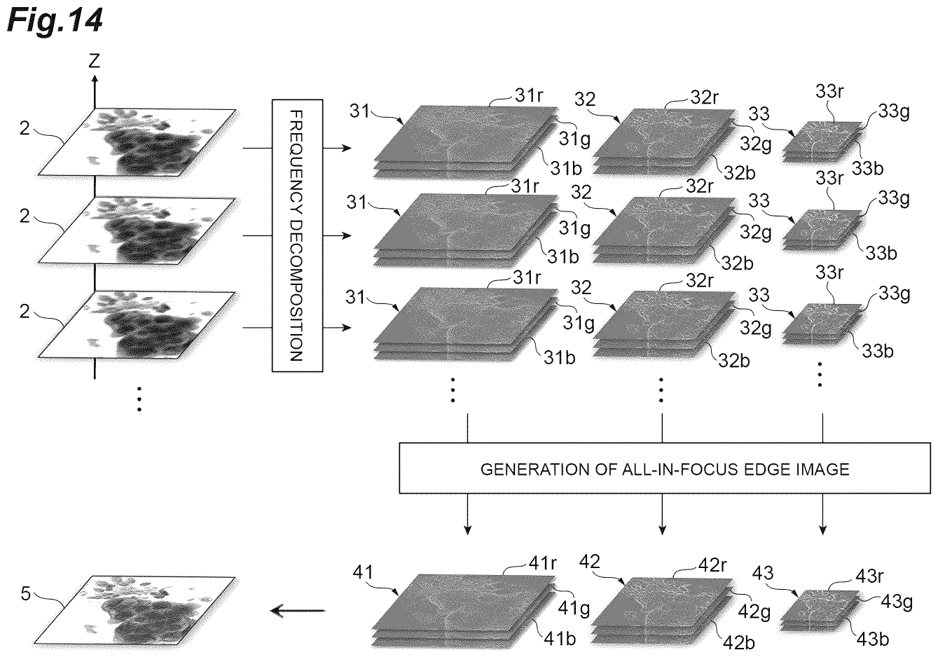

In the example of FIG. 14, frequency decomposition is performed three times, and as a result, an edge image 31 for each focal position, an edge image 32 for each focal position, and an edge image 33 for each focal position are generated. The frequency decomposition unit 12 calculates the image similarity in the edge image 33 for each focal position, and if the image similarity satisfies a predetermined similarity condition (step ST26: YES), the frequency decomposition unit 12 stops subsequent frequency decomposition.

When the image similarity between edge images for each focal position that share the same frequency band satisfies a predetermined similarity condition, it is considered that there is no significant difference in pixel values between an image including pixels corresponding to the focal position and an image not including pixels corresponding to the focal position. Therefore, the degree of focus may be determined independently from the frequency band. In some examples, when the image similarity satisfies a predetermined similarity condition, this may be considered as a determination index indicating that further frequency decomposition will not contribute to improving the accuracy of the all-in-focus image.

As an example of calculating the image similarity between edge images for each focal position that share the same frequency band, for example, SSIM (Structural SIMilarity) can be mentioned. The expression for calculating the similarity using the SSIM is shown, for example, in Equation 1.

$$\begin{matrix}[ Equation l ] & \\ DS = {\sum }_{M ∞ 1}^{L - 1} SSIM ( x [ M ] , y [ M + 1 ] ) & ( 1 )\end{matrix}$$

In Equation 1, the number of edge images for each focal position is L (L is an integer of 1 or more). Assuming that the M-th (M is an integer of 1 or more and L or less) edge image is a variable x[M] and the (M+1)-th edge image is a variable y[M+1], the SSIM between the M-th edge image and the (M+1)-th edge image is calculated, and the calculated results are summed to calculate the similarity DS.

The SSIM is a multiplication of comparison terms of brightness (l(x, y)), contrast (c(x, y)), and structure (s(x, y)) of the edge image. The definition of the SSIM is expressed by Equation 2.

$$\begin{matrix}[ Equation 2 ] & \\ SSIM ( x , y ) = {[ l ( x , y ) ]}^{α} \times {[ c ( x , y ) ]}^{β} \times {[ s ( x , y ) ]}^{γ} & ( 2 )\end{matrix}$$

In Equation 2, α, β, and γ are parameters for adjusting the weights of the three comparison terms. The brightness (1(x, y)), the contrast (c(x, y)), and the structure (s(x, y)) are expressed by Equations 3 to 5, respectively.

$$\begin{matrix}[ Equation 3 ] & \\ l ( x , y ) = \frac{2 {μ}_{x} {μ}_{y} + {C}_{1}}{{μ}_{x}^{2} + {μ}_{y}^{2} + {C}_{1}} & ( 3 )\end{matrix}$$

$$\begin{matrix}[ Equation 4 ] & \\ c ( x , y ) = \frac{2 {σ}_{x} {σ}_{y} + {C}_{2}}{{σ}_{x}^{2} + {σ}_{y}^{2} + {C}_{2}} & ( 4 )\end{matrix}$$

$$\begin{matrix}[ Equation 5 ] & \\ s ( x , y ) = \frac{{σ}_{xy} + {C}_{3}}{{σ}_{x} {σ}_{y} + {C}_{3}} & ( 5 )\end{matrix}$$

μₓ and μ_{y} are the mean values of x[M] and y[M+1], respectively, σₓ and σ_{y} are the standard deviations of x[M] and y[M+1], respectively, and σₓσ_{y} is the covariance between x[M] and y[M+1]. C₁ to C₃ are constants provided in Equations 3 to 5 to prevent instability in the output values when the denominators are close to 0.

Assuming that α, β, and γ are 1 in Equation 2 and C3 is C2/2 in Equations 4 and 5, the SSIM is calculated by Equation 6 using Equations 2 to 5.

$$\begin{matrix}[ Equation 6 ] & \\ SSIM ( x , y ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )} & ( 6 )\end{matrix}$$

As another example of calculating the image similarity between edge images for each focal position that share the same frequency band, for example, a PSNR (Peak Signal to Noise Ratio) can be mentioned. For example, when the sum of the differences between the PSNR of the M-th edge image and the PSNR of the (M+1)-th edge image between edge images for each focal position falls below a predetermined difference threshold, the frequency decomposition unit 12 stops frequency decomposition for that frequency band and subsequent frequency bands.

As still another example of calculating the image similarity, for example, a variance value can be mentioned. For example, when the sum of the differences between the variance value of the M-th edge image and the variance value of the (M+1)-th edge image between edge images for each focal position falls below a predetermined difference threshold, the frequency decomposition unit 12 stops frequency decomposition for that frequency band and subsequent frequency bands.

In step ST2A, the image similarity between edge images for each focal position that share the same frequency band may be calculated, and when the image similarity satisfies a predetermined similarity condition, subsequent frequency decomposition may be stopped. When the image similarity satisfies a predetermined similarity condition, it is considered that there is no significant difference in pixel values between an image including pixels corresponding to the focal position and an image not including pixels corresponding to the focal position, and accordingly, the frequency band can be determined to be an unnecessary frequency band in determining the degree of focus. Therefore, by stopping subsequent frequency decomposition, the speed at which the all-in-focus image 5 is generated can be improved without sacrificing accuracy.

### Fifth Modification Example

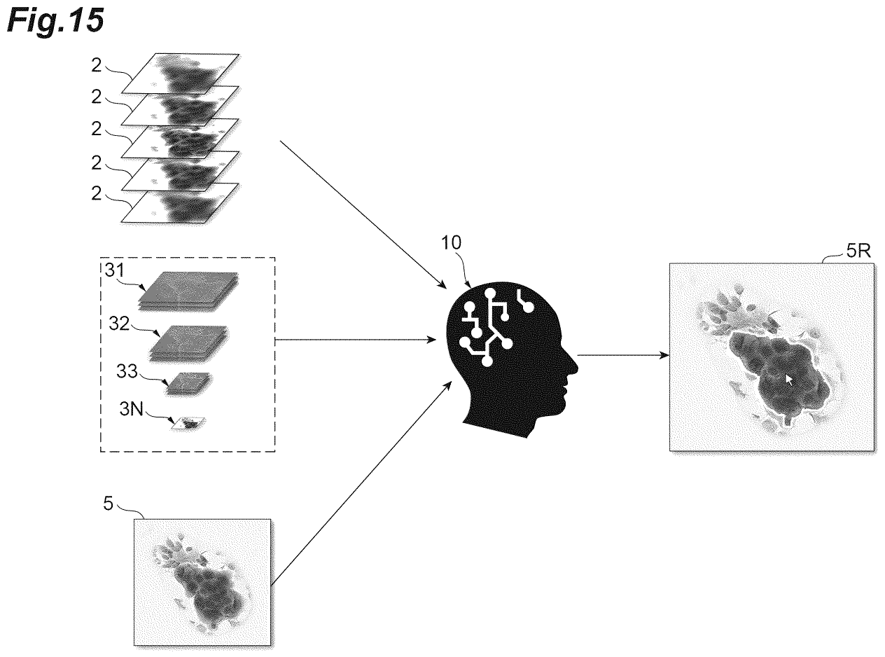

The all-in-focus image generation methods and modification examples may be applied to machine learning as a fifth modification example. For example, the all-in-focus image generation device 1 may further include a model generation unit, and an image information determination model may be generated by the model generation unit. FIG. 15 is a diagram showing an example of application of the image information determination model according to the fifth modification example. As shown in FIG. 15, the input data of an image information determination model 10 may be an original image 2 for each focal position, edge images 31 to 3 (N−1) for each frequency band and a bottom-layer image 3N for each focal position, or an all-in-focus image 5. In the example of FIG. 15, the output data of the image information determination model 10 is an image 5R in which only the specific region R selected from the all-in-focus image 5 is in focus. In some examples, the specific region R may be automatically selected by the image information determination model 10, rather than being selected by the user.

As another example of the output data of the image information determination model 10, an original image 2 for each focal position or an all-in-focus image 5 may be newly output. Alternatively, when an image for cytological diagnosis is prepared as input data, for example, image data may be output that reflects the results of detecting the position of a specific cell, estimating the cell type, and staining the cell according to the cell type and state. In addition, the image information determination model 10 is not limited to outputting image data. For example, the image information determination model 10 may determine whether or not to execute the method MT again.

In some examples, in step ST2 or step ST2A, the frequency decomposition unit 12 may perform frequency decomposition on each original image 2 using a method other than the Laplacian pyramid. Examples of other frequency decomposition methods include wavelet transform, discrete Fourier transform, fast Fourier transform, difference-of-Gaussian filtering or kernel-based filtering, and Hilbert transform.

In some examples, in step ST3, the all-in-focus edge image generation unit 13 may generate the all-in-focus edge images 41 to 4 (N−1) for each frequency band and the all-in-focus bottom-layer image 4N using a method other than the maximum value extraction method. For example, the all-in-focus edge image generation unit 13 may execute a principal component analysis method. In the principal component analysis method, for example, assuming that the edge image 31 for each focal position shown in FIG. 4 is a variable, each variable may be multiplied by a weighting constant to create a composite variable, and the value at which the variance of the composite variable is maximized may be extracted as a principal component. In addition, the all-in-focus edge image 41 may be constructed based on the principal components extracted at this time.

In addition to the maximum value extraction method, the all-in-focus edge image generation unit 13 may perform weighted addition, mean value calculation, outlier removal, and calculation of neighboring points. In addition, the all-in-focus edge image generation unit 13 may perform maximum value extraction using waveform fitting. The all-in-focus edge image generation unit 13 may perform maximum value extraction after converting the edge images 31 to 3 (N−1) for each frequency band and the bottom-layer image 3N for each focal position into grayscale.

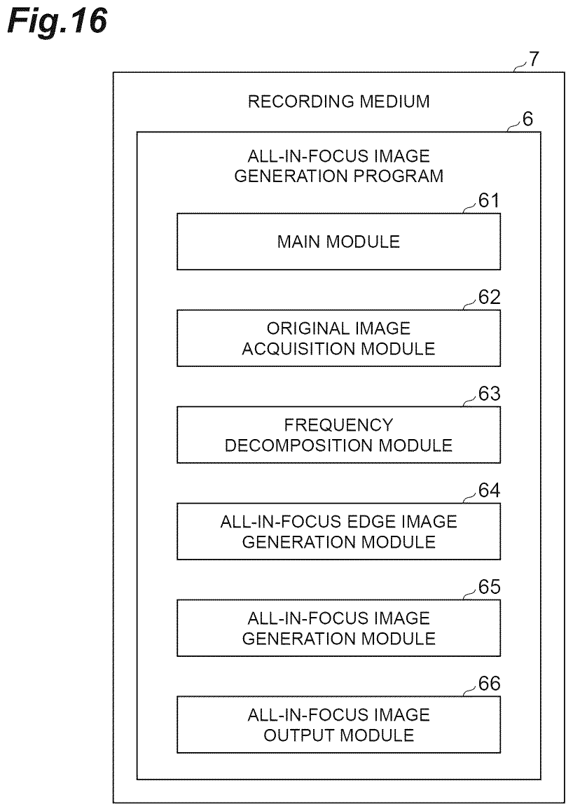

FIG. 16 is a block diagram showing an example of an all-in-focus image generation program and a recording medium. In the example shown in the same diagram, an all-in-focus image generation program 6 includes a main module 61, an original image acquisition module 62, a frequency decomposition module 63, an all-in-focus edge image generation module 64, an all-in-focus image generation module 65, and an all-in-focus image output module 66. The functions realized by the computer through the execution of the all-in-focus image generation program 6 are the same as the functions of the all-in-focus image generation device 1 described above. The all-in-focus image generation program 6 is provided by a computer-readable recording medium 7 such as a CD-ROM, DVD, or ROM. The all-in-focus image generation program 6 may be provided by a semiconductor memory, or may be provided as a computer data signal superimposed on a carrier wave through a network.

### EXAMPLES

Hereinafter, examples of the present disclosure will be described. In this example, all-in-focus images were generated using all-in-focus image generation methods of Example 1, Example 2, Comparative Example 1, and Comparative Example 2. Then, for each of the generated all-in-focus images, the uniformity of focus across all pixels was evaluated using a first evaluation index and a second evaluation index. In addition, in Example 1, Example 2, Comparative Example 1, and Comparative Example 2, the processing time from the acquisition of an image for each focal position to the generation of an all-in-focus image was measured.

In Example 1, the all-in-focus image was generated according to the method MT1 shown in FIG. 3. However, in step ST3, for the generation of each all-in-focus edge image, at each pixel position of each all-in-focus edge image, a pixel showing the maximum pixel value was extracted from the edge image for each focal position, and the extracted pixels were integrated to generate the all-in-focus edge image. On the other hand, for the generation of the all-in-focus bottom-layer image, at each pixel position of the all-in-focus bottom-layer image, a pixel showing the minimum pixel value was extracted from the bottom-layer image for each focal position, and the extracted pixels were integrated to generate the all-in-focus bottom-layer image.

In Example 2, in step ST3 of the method MT1 shown in FIG. 3, the all-in-focus image was generated using a principal component analysis method instead of the maximum value extraction method.

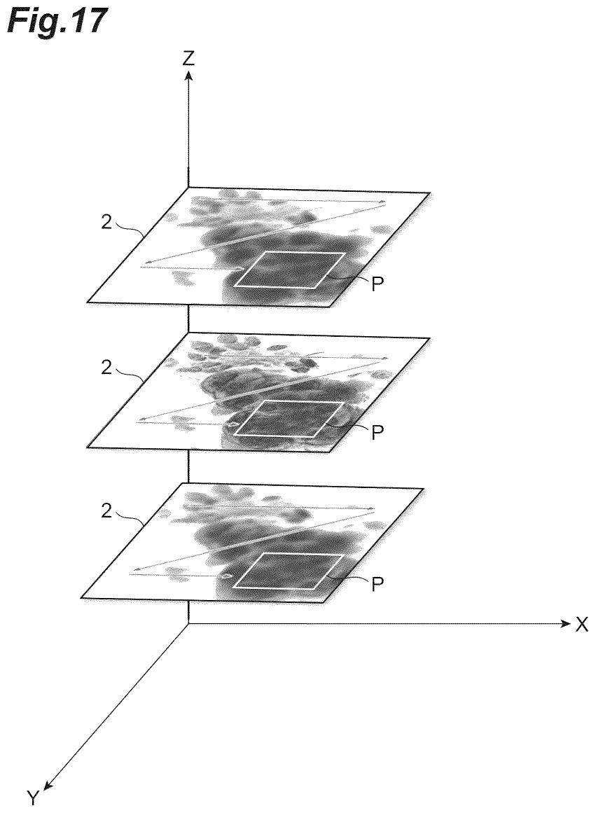

In Comparative Examples 1 and 2, an all-in-focus image generation method using patches was used instead of the method MT1. A patch is a partial region of an image that is formed of, for example, 16 pixels×16 pixels. As shown in FIG. 17, in Comparative Examples 1 and 2, for each original image, a patch P is scanned along a plane defined by the X axis and the Y axis. In Comparative Example 1, for each position of the patch P, the focal position is extracted using first-order differential. In Comparative Example 2, for each position of the patch P, the focal position is extracted using second-order differential. The focal position is extracted in units of pixels within the patch P. In Comparative Examples 1 and 2, the pixels from which the focal positions have been extracted are combined to generate the all-in-focus image.

The first evaluation index is Q_{S} (Structural similarity based metrics). In the evaluation using Q_{S}, the all-in-focus image is divided into a plurality of images using a window, and the image similarity between the divided images is evaluated. Q_{S} is calculated by Equation 7.

$$\begin{matrix}[ Equation 7 ] & \\ Qs ( x , y , f ) = \frac{1}{\vert W \vert} {\sum }_{w ∈ W} [ λ ( w ) Q ( x , f \vert w ) + ( 1 - λ ( w ) ) Q ( y , ( f \vert w ) ) ] & ( 7 )\end{matrix}$$

Here, W and w indicate a sliding window, Q(x, f|w) indicates a local quality index between a variable x and a variable f within the window w, and Q(y, f|w) indicates a local quality index between a variable y and a variable f within the window w. λ(w) indicates a weighting coefficient, which determines the weighting between Q(x, f|w) and Q(y, f|w). λ(w) is calculated by Equation (8).

$$\begin{matrix}[ Equation 8 ] & \\ λ ( w ) = \frac{S ( x \vert w )}{S ( x \vert w ) + S ( y \vert w )} & ( 8 )\end{matrix}$$

The second evaluation index is Q_{CB} (Human perception based metrics). In the evaluation using Q_{CB}, the all-in-focus image is divided into a plurality of images using a window. Then, in the evaluation using Q_{CB}, the contrast similarity in each of the divided images is calculated, and finally, the contrast similarity in the all-in-focus image is evaluated. First, the local contrast is calculated by Equation 9.

$$\begin{matrix}[ Equation 9 ] & \\ {C}_{A} ( x , y ) = \frac{{φ}_{k} ( x , y ) * {I}_{A} ( x , y )}{{φ}_{k + 1} ( x , y ) * {I}_{A} ( x , y )} - 1 & ( 9 )\end{matrix}$$

Here, φₖ is a Gaussian distribution function, and is calculated by Equation 10.

$$\begin{matrix}[ Equation 10 ] & \\ {φ}_{k} ( x , y ) = \frac{1}{{( \sqrt{2 {πσ}_{k}} )}^{2}} {e}^{\frac{{x}^{2} + {y}^{2}}{2 {σ}_{k}^{2}}} & ( 10 )\end{matrix}$$

Then, the local contrast calculated by Equation 9 is adjusted using a hyperparameter that reflects the degree of human visual perception. The adjusted contrast C_{A}′ is calculated by Equation 11.

$$\begin{matrix}[ Equation 11 ] & \\ {C}_{A}^{′} = \frac{t ( {( {C}_{A} )}^{p} )}{h ( {( {C}_{A} )}^{q} ) + Z} & ( 11 )\end{matrix}$$

Here, t, h, p, q, and Z are real scalar parameters, and determine the nonlinear shape of the masking function. For example, t=1, h=1, p=3, q=2, and Z=0.0001.

Then, a weighting coefficient λ_{A}(x, y) is calculated by Equation 12.

$$\begin{matrix}[ Equation 12 ] & \\ {λ}_{A} ( x , y ) = \frac{{{C}_{A}^{′} ( x , y )}^{2}}{{{C}_{A}^{′} ( x , y )}^{2} + {{C}_{B}^{′} ( x , y )}^{2}} & ( 12 )\end{matrix}$$

Then, a contrast similarity Q_{AF}(x, y) in the divided image is calculated by Equation 13.

$$\begin{matrix}[ Equation 13 ] & \\ {Q}_{AF} ( x , y ) = \{ \begin{matrix}\frac{{C}_{F}^{′} ( x , y )}{{C}_{A}^{′} ( x , y )} , & if {C}_{A}^{′} ( x , y ) > {C}_{F}^{′} ( x , y ) \\ \frac{{C}_{A}^{′} ( x , y )}{{C}_{F}^{′} ( x , y )} , & otherwise\end{matrix} & ( 13 )\end{matrix}$$

A contrast similarity Q_{BF}(x, y) in another divided image is also calculated by Equation 13. Then, based on the weighting coefficient and contrast similarities calculated by Equations 12 and 13, a global quality map Q_{GQM}(x, y) is calculated by Equation 14.

$$\begin{matrix}[ Equation 14 ] & \\ {Q}_{GQM} ( x , y ) = {λ}_{A} ( x , y ) {Q}_{AF} ( x , y ) + {Q}_{B} ( x , y ) {Q}_{BF} ( x , y ) & ( 14 )\end{matrix}$$

Finally, the contrast similarity in the all-in-focus image is calculated by averaging the global quality map Q_{GQM} (x, y) using Equation 15.

$$\begin{matrix}[ Equation 15 ] & \\ {Q}_{CB} = \overline{{Q}_{GQM} ( x , y )} & ( 15 )\end{matrix}$$

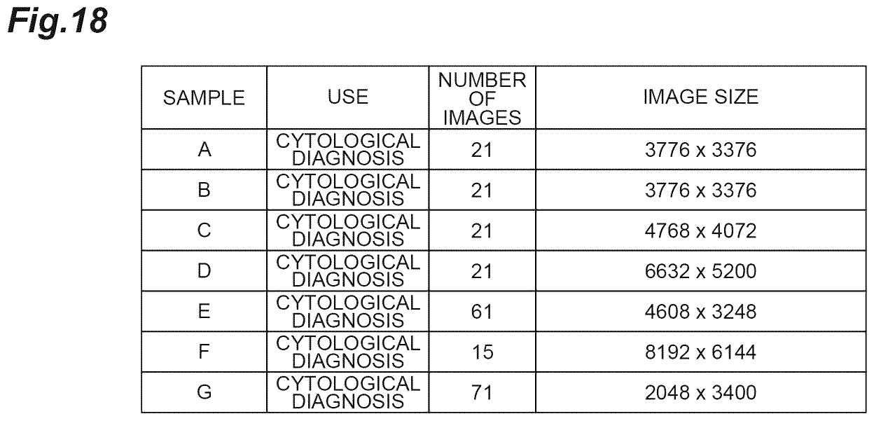

The samples to be evaluated are a plurality of images equivalent to the original image 2 for each focal position in FIG. 3. As shown in FIG. 18, each of samples A to G is a plurality of images for cytological diagnosis. The number of images and the size of each image differ among the samples A to G.

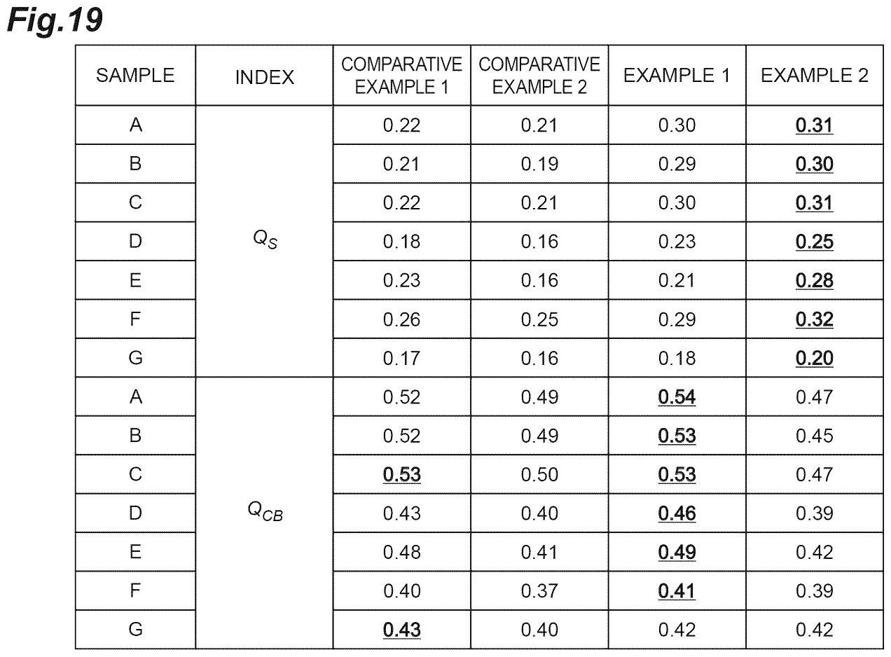

FIG. 19 shows the results of calculating Q_{S}, which is the first evaluation index, and Q_{CB}, which is the second evaluation index, in Example 1, Example 2, Comparative Example 1, and Comparative Example 2. Higher values of Q_{S} and Q_{CB} indicate more uniform focus across all pixels and higher quality of the all-in-focus image.

Regarding Q_{S} that is the first evaluation index, it can be seen that Q_{S} calculated in Example 2 is larger than Q_{S} calculated in Comparative Examples 1 and 2 for all samples. Regarding Q_{CB} that is the second evaluation index, it can be seen that Q_{CB} calculated in Example 1 is larger than Q_{CB} calculated in Comparative Example 2 for all samples. In addition, it can be seen that Q_{CB} calculated in Example 1 is larger than Q_{CB} calculated in Comparative Example 1 for the samples A, B, and D to F. Q_{CB} calculated in Example 1 is the same as Q_{CB} calculated in Comparative Example 1 for the sample C. For the sample G, it can be said that Q_{CB} calculated in Example 1 is smaller than Q_{CB} calculated in Comparative Example 1 but there is no significant difference therebetween.

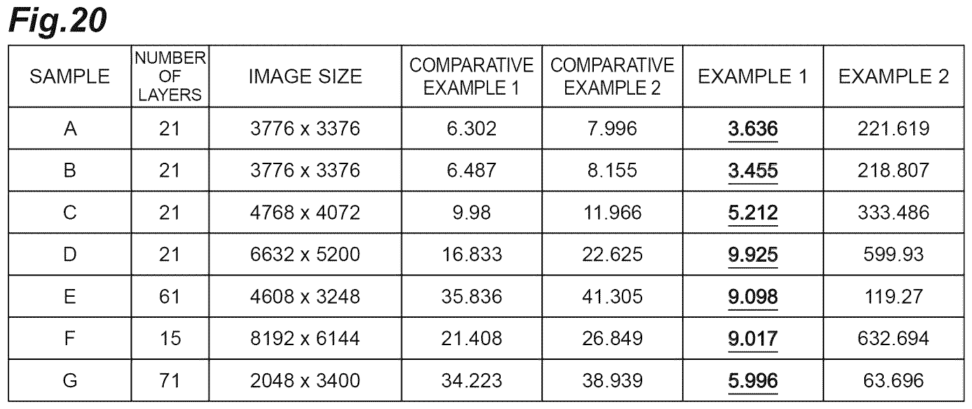

FIG. 20 shows the results of measuring the processing time from the acquisition of an image for each focal position to the generation of an all-in-focus image in Example 1, Example 2, Comparative Example 1, and Comparative Example 2. It can be seen that the processing time measured in Example 1 is shorter than the processing times measured in Comparative Examples 1 and 2 for all samples. In particular, it can be seen that, for the samples E and G with a large number of images, the processing time measured in Example 1 is reduced to ¼ to ⅙ of the processing times measured in Comparative Examples 1 and 2.

An example method of generating an all-in-focus image may include: an original image acquisition step for acquiring an original image for each focal position of an object by capturing an image of the object while shifting the focal position in a predetermined direction; a frequency decomposition step for performing frequency decomposition on the original image for each focal position to generate an edge image for each frequency band; an all-in-focus edge image generation step for generating an all-in-focus edge image for each frequency band by integrating the edge images for each frequency band in the predetermined direction; and an all-in-focus image generation step for generating an all-in-focus image by integrating the all-in-focus edge images for each frequency band.

In some examples, original images for each focal position, each having a different focal position, are acquired, and edge images for each frequency band are generated by extracting, for each frequency band, the frequency components included in each original image for each focal position. Since the frequency components include information indicating the focal position in each original image, performing frequency decomposition on each original image enables accurate extraction of the focal position in the edge image for each frequency band. In the all-in-focus image generated for each frequency band by integrating the edge images for each frequency band, information indicating different focal positions for each frequency band is reflected, and all pixels are in focus. Accordingly, the all-in-focus image may be generated with high accuracy without extracting a specific region from the original image for each focal position.

In some examples, in the frequency decomposition step, the original image for each focal position may be decomposed into a plurality of color component images and each of the plurality of color component images may be frequency-decomposed to generate the edge images for each frequency band corresponding to the plurality of color component images. By performing frequency decomposition on each of the plurality of color component images and generating edge images for each frequency band corresponding to the plurality of color component images, information indicating different focal positions for each color component image can be further reflected in the all-in-focus image. Accordingly, the all-in-focus image may be generated with even higher accuracy.

In some examples, in the frequency decomposition step, an image not including the focal position, among the original images for each focal position, may be excluded from targets of frequency decomposition. Since the number of images to be decomposed in the frequency decomposition step can be reduced by excluding the image not including the focal position, the speed at which the all-in-focus image is generated may be improved.

In some examples, the method may further include: a selection step for selecting a specific region in the original image for each focal position, wherein, in the frequency decomposition step, the specific region in each of the original images for each focal position may be frequency-decomposed to generate an edge image for each frequency band in the specific region. Since the amount of data of the image to be decomposed in the frequency decomposition step can be reduced, the speed at which the all-in-focus image is generated may be improved. In addition, the specific region may be selected to reduce the amount of data, without affecting the accuracy of the all-in-focus image.

In some examples, the method may further include: a conversion step for selecting a specific region in the all-in-focus image and converting the all-in-focus image into an image focused on the specific region. Since the all-in-focus image can be converted into an image in which the specific region is selectively placed in focus, the usability of the all-in-focus image may be improved.

In some examples, in the frequency decomposition step, the edge images for each frequency band may be generated in order from the highest frequency band, and for the edge images for each frequency band, an image similarity between edge images for each focal position that share the same frequency band may be calculated, and subsequent frequency decomposition may be stopped when the image similarity satisfies a predetermined similarity condition. When the image similarity satisfies a predetermined similarity condition, it is considered that there is no significant difference in pixel values between an image including pixels corresponding to the focal position and an image not including pixels corresponding to the focal position, and accordingly, the frequency band can be determined to be an unnecessary frequency band in determining the degree of focus. Therefore, by stopping subsequent frequency decomposition, the speed at which the all-in-focus image is generated can be improved without sacrificing accuracy.

An example device for generating an all-in-focus image may include: an original image acquisition unit that acquires an original image for each focal position of an object by capturing an image of the object while shifting the focal position in a predetermined direction; a frequency decomposition unit that performs frequency decomposition on the original image for each focal position to generate an edge image for each frequency band; an all-in-focus edge image generation unit that generates an all-in-focus edge image for each frequency band by integrating the edge images for each frequency band in the predetermined direction; and an all-in-focus image generation unit that generates an all-in-focus image by integrating the all-in-focus edge images for each frequency band.

In some examples, original images for each focal position, each having a different focal position, are acquired, and edge images for each frequency band are generated by extracting, for each frequency band, the frequency components included in each original image for each focal position. Since the frequency components include information indicating the focal position in each original image, performing frequency decomposition on each original image enables accurate extraction of the focal position in the edge image for each frequency band. In the all-in-focus image generated for each frequency band by integrating the edge images for each frequency band, information indicating different focal positions for each frequency band is reflected, and all pixels are in focus. Accordingly, the all-in-focus image may be generated with high accuracy without extracting a specific region from the original image for each focal position.

In some examples, the frequency decomposition unit may decompose the original image for each focal position into a plurality of color component images and perform frequency decomposition on each of the plurality of color component images to generate the edge images for each frequency band corresponding to the plurality of color component images. By performing frequency decomposition on each of the plurality of color component images and generating edge images for each frequency band corresponding to the plurality of color component images, information indicating different focal positions for each color component image can be further reflected in the all-in-focus image. Accordingly, the all-in-focus image may be generated with even higher accuracy.

In some examples, the frequency decomposition unit may exclude an image not including the focal position, among the original images for each focal position, from targets of frequency decomposition. By excluding the image not including the focal position, the number of images to be decomposed by the frequency decomposition unit can be reduced, the speed at which the all-in-focus image is generated may be improved.

In some examples, the all-in-focus image generation device may further include: a selection unit that selects a specific region in the original image for each focal position, wherein the frequency decomposition unit frequency—may decompose the specific region in each of the original images for each focal position to generate an edge image for each frequency band in the specific region for each frequency band. Since the amount of data of the image to be decomposed by the frequency decomposition unit can be reduced, the speed at which the all-in-focus image is generated may be improved. In addition, the specific region referred to herein may be selected to reduce the amount of data, without affecting the accuracy of the all-in-focus image according to this method.

In some examples, the all-in-focus image generation device may further include: a conversion unit that selects a specific region in the all-in-focus image and converts the all-in-focus image into an image focused on the specific region. Since the all-in-focus image can be converted into an image in which the specific region is selectively place in focus, the usability of the all-in-focus image may be improved.

In some examples, the frequency decomposition unit may generate the edge images for each frequency band in order from the highest frequency band, and for the edge images for each frequency band, an image similarity between edge images for each focal position that share the same frequency band is calculated, and subsequent frequency decomposition is stopped when the image similarity satisfies a predetermined similarity condition. When the image similarity satisfies a predetermined similarity condition, it is considered that there is no significant difference in pixel values between an image including pixels corresponding to the focal position and an image not including pixels corresponding to the focal position, and accordingly, the frequency band can be determined to be an unnecessary frequency band in determining the degree of focus. Therefore, by stopping subsequent frequency decomposition, the speed at which the all-in-focus image is generated can be improved without sacrificing accuracy.

Disclosed herein is an all-in-focus image generation program causing a computer to execute: an original image acquisition step for acquiring an original image for each focal position of an object by capturing an image of the object while shifting the focal position in a predetermined direction; a frequency decomposition step for performing frequency decomposition on the original image for each focal position to generate an edge image for each frequency band; an all-in-focus edge image generation step for generating an all-in-focus edge image for each frequency band by integrating the edge images for each frequency band in the predetermined direction; and an all-in-focus image generation step for generating an all-in-focus image by integrating the all-in-focus edge images for each frequency band.

In some examples, original images for each focal position, each having a different focal position, are acquired, and edge images for each frequency band are generated by extracting, for each frequency band, the frequency components included in each original image for each focal position. Since the frequency components include information indicating the focal position in each original image, performing frequency decomposition on each original image enables accurate extraction of the focal position in the edge image for each frequency band. In the all-in-focus image generated for each frequency band by integrating the edge images for each frequency band, information indicating different focal positions for each frequency band is reflected, and all pixels are in focus. Accordingly, the all-in-focus image may be generated with high accuracy without extracting a specific region from the original image for each focal position.

An example method of generating an all-in-focus image may include: acquiring, as a respective original image for each focal position related to an object, an image captured for each focal position by capturing an image of the object while shifting the focal position in a predetermined direction; extracting a frequency component in each of the original images for each focal position to generate a respective edge image for each frequency band; generating a respective all-in-focus edge image for each frequency band by integrating the edge images for each frequency band in the predetermined direction; and generating the all-in-focus image by integrating the all-in-focus edge images for each frequency band.

In some examples, generating the respective edge image for each frequency band may include generating the edge images for each frequency band corresponding to the plurality of color component images by decomposing the original image for each focal position into a plurality of color component images and extracting a frequency component in each of the plurality of color component images.

In some examples, generating the respective edge image for each frequency band may include excluding an image not including the focal position, among the original images for each focal position from targets of generation of the edge image of each frequency band.

In some examples, the method may further include selecting a specific region in the original image for each focal position. Generating the respective edge image for each frequency band may include extracting a frequency component in the specific region in each of the original images for each focal position to generate the edge image for each frequency band in the specific region.

In some examples, the method may further include selecting a specific region in the all-in-focus image and converting the all-in-focus image into an image focused on the specific region.

In some examples, generating the respective edge image for each frequency band may include: generating the respective edge image for each frequency band in order from the highest frequency band; calculating, in the edge images for each frequency band, an image similarity between edge images for each focal position that share a common frequency band; and stopping subsequent generation of the edge image for each frequency band when the image similarity satisfies a predetermined similarity condition.

An example all-in-focus imaging device may include an imaging device configured to: acquire a first original image by capturing an image of an object at a first focal position; and acquire a second original image by capturing an image of the object at a second focal position that is different from the first focal position. The example all-in-focus imaging device may further include a controller configured to: generate, by performing frequency decomposition: a first edge image of the first original image corresponding to a first frequency band; a second edge image of the first original image corresponding to a second frequency band that is different from the first frequency band; a first edge image of the second original image corresponding to the first frequency band; and a second edge image of the second original image corresponding to the second frequency band. The controller may be further configured to: integrate the first edge image of the first original image and the first edge image of the second original image to generate a first all-in-focus edge image of the first frequency band; integrate the second edge image of the first original image and the second edge image of the second original image to generate a second all-in-focus edge image of the second frequency band; and integrate the first all-in-focus edge image and the second all-in-focus edge image to generate an all-in-focus image.

In some examples, the controller may be further configured to generate, by performing color decomposition on the first original image, a first color component image and a second color component image. The controller may generate the first edge image of the first original image by: performing frequency decomposition on the first color component image to generate a first color edge image of the first original image; performing frequency decomposition on the second color component image to generate a second color edge image of the first original image; and integrating the first color edge image and the second color edge image to generate the first edge image.

In some examples, the controller may generate the first all-in-focus edge image of the first frequency band by integrating: the first edge image of the first original image generated by performing frequency decomposition on the first original image; and the first edge image of the second original image generated by performing frequency decomposition on the second original image.

In some examples, the imaging device may be further configured to capture a plurality of images of the object, the plurality of images including the first original image, the second original image and a third original image which does not include a focal position. The controller may exclude the third original image in generating the all-in-focus image.

In some examples, the controller may be further configured to: select a portion of the first original image as a first specific region; select a portion of the second original image as a second specific region; generate the first edge image and the second edge image of the first original image based on the first specific region; and generate the first edge image and the second edge image of the second original image based on the second specific region.

In some examples, the controller may be further configured to: select a portion of the all-in-focus image as a specific region; and transform the all-in-focus image so that the specific region is in focus.

In some examples, the controller may be configured to: generate the first edge image of the first original image corresponding to the first frequency band; after generating the first edge image of the first original image, generate the second edge image of the first original image corresponding to the second frequency band having a frequency lower than the first frequency band; generate the first edge image of the second original image corresponding to the first frequency band; and after generating the first edge image of the second original image, generate the second edge image of the second original image corresponding to the second frequency band.

In some examples, the controller may be further configured to: calculate an image similarity based on the second edge image of the first original image and the second edge image of the second original image; generate, by performing frequency decomposition, a third edge image of the first original image corresponding to a third frequency band having a frequency lower than the second frequency band, if the image similarity satisfies a predetermined similarity condition; and generate, by performing frequency decomposition, a third edge image of the second original image corresponding to the third frequency band, if the image similarity satisfies the similarity condition.

In some examples, the controller may be configured to: generate a compressed image by reducing a resolution of the first original image; generate a resized image by resizing the compressed image; and generate the first edge image of the first original image by subtracting the resized image from the first original image.

In some examples, the controller may be configured to generate the first all-in-focus edge image by selecting, for each corresponding pixel between the plurality of pixels constituting the first edge image of the first original image and the plurality of pixels constituting the first edge image of the second original image, a pixel with the highest pixel value.

An example method of generating an all-in-focus image may include: acquiring a first original image by capturing an image of an object at a first focal position; acquiring a second original image by capturing an image of the object at a second focal position that is different from the first focal position; generating, by performing frequency decomposition: a first edge image of the first original image corresponding to a first frequency band; a second edge image of the first original image corresponding to a second frequency band that is different from the first frequency band; a first edge image of the second original image corresponding to the first frequency band; and a second edge image of the second original image corresponding to the second frequency band; integrating the first edge image of the first original image and the first edge image of the second original image to generate a first all-in-focus edge image of the first frequency band; integrating the second edge image of the first original image and the second edge image of the second original image to generate a second all-in-focus edge image of the second frequency band; and integrating the first all-in-focus edge image and the second all-in-focus edge image to generate the all-in-focus image.

In some examples, the method may further include: generating, by performing color decomposition on the first original image, a first color component image and a second color component image.

Generating the first edge image of the first original image may include: generating a first color edge image of the first original image by performing frequency decomposition on the first color component image; generating a second color edge image of the first original image by performing frequency decomposition on the second color component image; and generating the first edge image of the first original image by integrating the first color edge image and the second color edge image.

In some examples, the method may further include: capturing a plurality of images of the object, the plurality of images including the first original image, the second original image and a third original image which does not include a focal position; and excluding the third original image in generating the all-in-focus image.

In some examples, the method may further include: selecting a portion of the first original image as a first specific region; selecting a portion of the second original image as a second specific region; generating the first edge image and the second edge image of the first original image based on the first specific region; and generating the first edge image and the second edge image of the second original image based on the second specific region.

What is claimed is:

1. A method of generating an all-in-focus image, the method comprising:
acquiring, as a respective original image for each focal position related to an object, an image captured for each focal position by capturing an image of the object while shifting the focal position in a predetermined direction;
performing frequency decomposition in each of the original images for each focal position to generate a respective edge image for each frequency band;
generating a respective all-in-focus edge image for each frequency band by integrating the edge images for each frequency band in the predetermined direction; and
generating the all-in-focus image by integrating the all-in-focus edge images for each frequency band.

2. The method according to claim 1, wherein performing frequency decomposition includes generating the edge images for each frequency band corresponding to a plurality of color component images by decomposing the original image for each focal position into a plurality of color component images and performing frequency decomposition on each of the plurality of color component images.

3. The method according to claim 1, wherein performing frequency decomposition includes excluding an image not including the focal position, among the original images for each focal position from targets of generation of the edge image of each frequency band.

4. The method according to claim 1, further comprising selecting a specific region in the original image for each focal position,
wherein performing frequency decomposition includes performing frequency decomposition on the specific region in each of the original images for each focal position to generate the edge image for each frequency band in the specific region.

5. The method according to claim 1, further comprising selecting a specific region in the all-in-focus image and converting the all-in-focus image into an image focused on the specific region.

6. The method according to claim 1, wherein performing frequency decomposition includes:
generating the respective edge image for each frequency band in order from highest frequency band;
calculating, in the edge images for each frequency band, an image similarity between edge images for each focal position that share a common frequency band; and
stopping subsequent frequency decomposition when the image similarity satisfies a predetermined similarity condition.

7. An all-in-focus imaging device comprising:
an imaging device configured to:
acquire a first original image by capturing an image of an object at a first focal position; and
acquire a second original image by capturing an image of the object at a second focal position that is different from the first focal position; and
a controller configured to:
generate, by performing frequency decomposition:
a first edge image of the first original image corresponding to a first frequency band;
a second edge image of the first original image corresponding to a second frequency band that is different from the first frequency band;
a first edge image of the second original image corresponding to the first frequency band; and
a second edge image of the second original image corresponding to the second frequency band;
integrate the first edge image of the first original image and the first edge image of the second original image to generate a first all-in-focus edge image of the first frequency band;
integrate the second edge image of the first original image and the second edge image of the second original image to generate a second all-in-focus edge image of the second frequency band; and
integrate the first all-in-focus edge image and the second all-in-focus edge image to generate an all-in-focus image.

8. The all-in-focus imaging device according to claim 7,
wherein the controller is further configured to generate, by performing color decomposition on the first original image, a first color component image and a second color component image, and
wherein the controller generates the first edge image of the first original image by:
performing frequency decomposition on the first color component image to generate a first color edge image of the first original image;
performing frequency decomposition on the second color component image to generate a second color edge image of the first original image; and
integrating the first color edge image and the second color edge image to generate the first edge image.

9. The all-in-focus imaging device according to claim 7, wherein the controller generates the first all-in-focus edge image of the first frequency band by integrating:
the first edge image of the first original image generated by performing frequency decomposition on the first original image; and
the first edge image of the second original image generated by performing frequency decomposition on the second original image.

10. The all-in-focus imaging device according to claim 7, wherein the imaging device is further configured to capture a plurality of images of the object, the plurality of images including the first original image, the second original image and a third original image which does not include a focal position, and
wherein the controller excludes the third original image in generating the all-in-focus image.

11. The all-in-focus imaging device according to claim 7, wherein the controller is further configured to:
select a portion of the first original image as a first specific region;
select a portion of the second original image as a second specific region;
generate the first edge image and the second edge image of the first original image based on the first specific region; and
generate the first edge image and the second edge image of the second original image based on the second specific region.

12. The all-in-focus imaging device according to claim 7, wherein the controller is further configured to:
select a portion of the all-in-focus image as a specific region; and
transform the all-in-focus image so that the specific region is in focus.

13. The all-in-focus imaging device according to claim 7, wherein the controller is configured to:
generate the first edge image of the first original image corresponding to the first frequency band;
after generating the first edge image of the first original image, generate the second edge image of the first original image corresponding to the second frequency band having a frequency lower than the first frequency band;
generate the first edge image of the second original image corresponding to the first frequency band; and
after generating the first edge image of the second original image, generate the second edge image of the second original image corresponding to the second frequency band.

14. The all-in-focus imaging device according to claim 13, wherein the controller is further configured to:
calculate an image similarity based on the second edge image of the first original image and the second edge image of the second original image;
generate, by performing frequency decomposition, a third edge image of the first original image corresponding to a third frequency band having a frequency lower than the second frequency band, if the image similarity satisfies a predetermined similarity condition; and
generate, by performing frequency decomposition, a third edge image of the second original image corresponding to the third frequency band, if the image similarity satisfies the similarity condition.

15. The all-in-focus imaging device according to claim 7, wherein the controller is configured to:
generate a compressed image by reducing a resolution of the first original image;
generate a resized image by resizing the compressed image; and
generate the first edge image of the first original image by subtracting the resized image from the first original image.

16. The all-in-focus imaging device according to claim 7,
wherein the controller is configured to generate the first all-in-focus edge image by selecting, for each corresponding pixel between the plurality of pixels constituting the first edge image of the first original image and the plurality of pixels constituting the first edge image of the second original image, a pixel with the highest pixel value.

17. A method of generating an all-in-focus image, the method comprising:
acquiring a first original image by capturing an image of an object at a first focal position;
acquiring a second original image by capturing an image of the object at a second focal position that is different from the first focal position;
generating, by performing frequency decomposition:
a first edge image of the first original image corresponding to a first frequency band;
a second edge image of the first original image corresponding to a second frequency band that is different from the first frequency band;
a first edge image of the second original image corresponding to the first frequency band; and
a second edge image of the second original image corresponding to the second frequency band;
integrating the first edge image of the first original image and the first edge image of the second original image to generate a first all-in-focus edge image of the first frequency band;
integrating the second edge image of the first original image and the second edge image of the second original image to generate a second all-in-focus edge image of the second frequency band; and
integrating the first all-in-focus edge image and the second all-in-focus edge image to generate the all-in-focus image.

18. The method according to claim 17, the method further comprising:
generating, by performing color decomposition on the first original image, a first color component image and a second color component image;
wherein generating the first edge image of the first original image includes:
generating a first color edge image of the first original image by performing frequency decomposition on the first color component image;
generating a second color edge image of the first original image by performing frequency decomposition on the second color component image; and
generating the first edge image of the first original image by integrating the first color edge image and the second color edge image.

19. The method according to claim 17, the method further comprising:
capturing a plurality of images of the object, the plurality of images including the first original image, the second original image and a third original image which does not include a focal position; and
excluding the third original image in generating the all-in-focus image.

20. The method according to claim 17, the method further comprising:
selecting a portion of the first original image as a first specific region;
selecting a portion of the second original image as a second specific region;
generating the first edge image and the second edge image of the first original image based on the first specific region; and
generating the first edge image and the second edge image of the second original image based on the second specific region.
